(19) United States
(12) Patent Application Publication
(10) Pub. No.: US 2025/0308796 A1
(43) Pub. Date: Oct. 2, 2025

(54) MULTILAYER CERAMIC CAPACITOR

(71) Applicant: Murata Manufacturing Co., Ltd., Nagaokakyo-shi (JP)

(72) Inventors: Ryousuke SATOU, Nagaokakyo-shi (JP); Daisuke MINAMI, Nagaokakyo-shi (JP); Shinya HORIUCHI, Nagaokakyo-shi (JP); Chitose TAKAHASHI, Nagaokakyo-shi (JP)

(73) Assignee: Murata Manufacturing Co., Ltd., Nagaokakyo-shi (JP)

(21) Appl. No.: 19/171,383

(22) Filed: Apr. 7, 2025

Related U.S. Application Data
(63) Continuation of application No. PCT/JP2024/012835, filed on Mar. 28, 2024.

(51) Int. Cl. H01G 4/232; H01G 4/008; H01G 4/12; H01G 4/248; H01G 4/30

(52) U.S. Cl. CPC H01G 4/2325; H01G 4/008; H01G 4/1209; H01G 4/248; H01G 4/30

(57) ABSTRACT

Provided are multilayer ceramic capacitors. A multilayer ceramic capacitor includes a multilayer body, a first external electrode provided on a first end surface of the multilayer body and connected to internal electrodes, and a second external electrode provided on a second end surface BB of the multilayer body and connected to internal electrodes. The first external electrode includes a first base electrode layer connected to the internal electrodes. The first base electrode layer includes electrically conductive metal and glass. The glass is covered with a thin metal film.

### CROSS-REFERENCE TO RELATED APPLICATION

This application is a continuation of international application no. PCT/JP2024/012835, filed Mar. 28, 2024, the entire contents of which are hereby incorporated by reference.

### TECHNICAL FIELD

The present disclosure relates to a multilayer ceramic capacitor.

### BACKGROUND ART

There are multilayer ceramic capacitors, each including a multilayer body in which internal electrodes and dielectric layers are alternately laminated and external electrodes connected to the internal electrodes. Such multilayer ceramic capacitors are one important type of electronic component.

### SUMMARY

### Exemplary Problems to be Solved

In recent years, due to the widespread use of electric vehicles and smartphones, there has been an increasing demand for multilayer ceramic capacitors having high reliability and capable of operating stably.

An exemplary embodiment of the present disclosure provides multilayer ceramic capacitors, each having excellent reliability.

### Exemplary Solution(s)

To solve the above-mentioned exemplary problems, an exemplary embodiment of the present disclosure provides a multilayer ceramic capacitor that includes a multilayer body including a plurality of dielectric layers and a plurality of internal electrodes which are respectively laminated, a first main surface and a second main surface opposed to each other in a lamination direction, a first lateral surface and a second lateral surface opposed to each other in a width direction orthogonal or substantially orthogonal to the lamination direction, and a first end surface and a second end surface opposed to each other in a length direction orthogonal or substantially orthogonal to the lamination direction and the width direction. A first external electrode is provided on the first end surface and is connected to the plurality of internal electrodes. A second external electrode is provided on the second end surface and is connected to the plurality of internal electrodes. The first external electrode includes a first base electrode layer connected to the plurality of internal electrodes and including electrically conductive metal and glass, and a first plated layer provided on the first base electrode layer, and the first base electrode layer includes a metal thin film which is a region between the glass and the first plated layer, includes the electrically conductive metal, and has a thickness of 1 μm or less.

### Effects

According to exemplary embodiments of the present disclosure, it is possible to provide multilayer ceramic capacitors, each having excellent reliability.

### BRIEF DESCRIPTION OF THE DRAWINGS

FIG. 1 is a schematic perspective view of a multilayer ceramic capacitor 1 according to a first exemplary embodiment.

FIG. 2 is a cross-sectional view taken along the line II-II of FIG. 1.

FIG. 3 is a cross-sectional view taken along the line III-III of FIG. 1.

FIG. 4 is a cross-sectional view taken along the line IV-IV of FIG. 1.

FIG. 5 is a schematic perspective view of a multilayer ceramic capacitor 1 according to a second exemplary embodiment.

FIG. 6 is a cross-sectional view taken along the line VI-VI of FIG. 5.

FIG. 7 is a view of a first external electrode 3A according to the second exemplary embodiment as viewed in a length direction L.

FIG. 8 is an enlarged view of a portion VIII in FIG. 6.

FIG. 9 is an enlarged view of a portion IX in FIG. 8.

### DETAILED DESCRIPTION

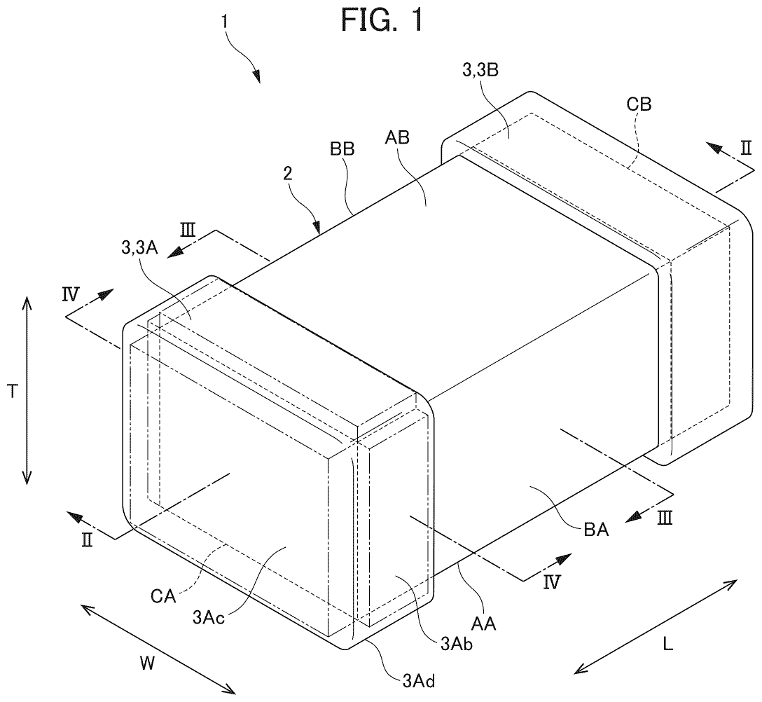

Hereinafter, a multilayer ceramic capacitor 1 according to an exemplary embodiment of the present disclosure will be described with reference to FIGS. 1 to 4.

### Multilayer Ceramic Capacitor 1

As shown in FIG. 1, the multilayer ceramic capacitor 1 is a multilayer ceramic capacitor including a two-terminal structure. The multilayer ceramic capacitor 1 includes a multilayer body 2, a first external electrode 3A, and a second external electrode 3B. The multilayer body 2 has a substantially rectangular parallelepiped shape and has six outer surfaces. The multilayer body 2 includes an inner layer portion 11 in which dielectric layers 14 and internal electrodes 15 are laminated. The first external electrode 3A and the second external electrode 3B may be collectively referred to as an “external electrode 3”.

In the present specification, a direction in which the dielectric layers 14 and the internal electrodes 15 are stacked or laminated in the multilayer ceramic capacitor 1 is referred to as a lamination direction T. One of the directions orthogonal or substantially orthogonal to the lamination direction Tis defined as a length direction L. A direction orthogonal or substantially orthogonal to the length direction L and the lamination direction T is defined as a width direction W.

Among the six outer surfaces of the multilayer body 2, a pair of outer surfaces provided on both sides in the lamination direction T are defined as a first main surface AA and a second main surface AB, a pair of outer surfaces extending in the lamination direction T and provided on both sides in the width direction W are defined as a first lateral surface BA and a second lateral surface BB, and a pair of outer surfaces extending in the lamination direction T and provided on both sides in the length direction L are defined as a first end surface CA and a second end surface CB. The first main surface AA and the second main surface AB may be collectively referred to as “main surface A”. The first lateral surface BA and the second lateral surface BB may be collectively referred to as “lateral surface B”. The first end surface CA and the second end surface CB may be collectively referred to as “end surface C”.

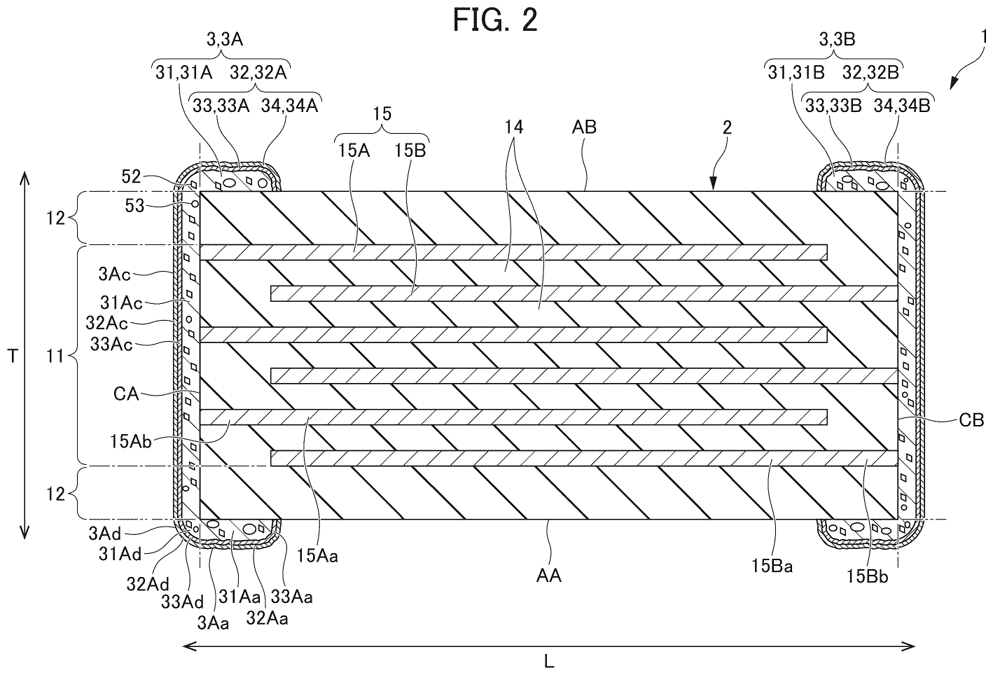

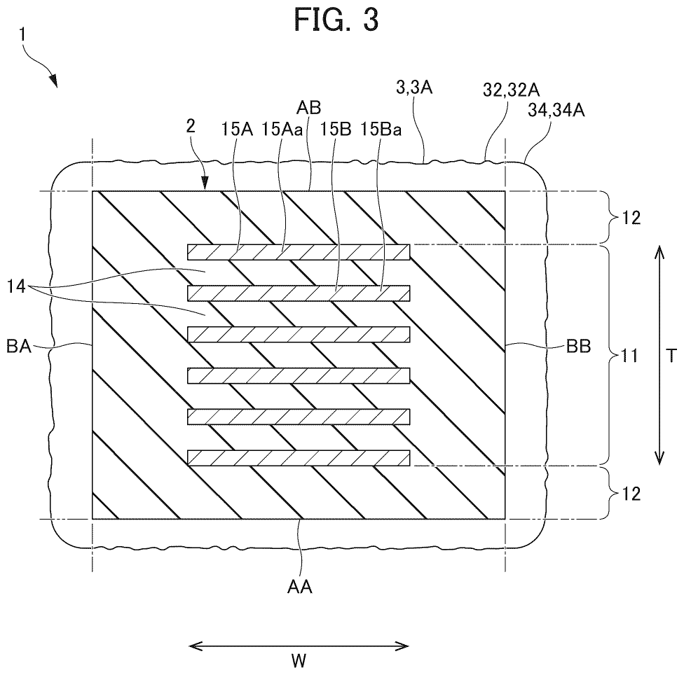

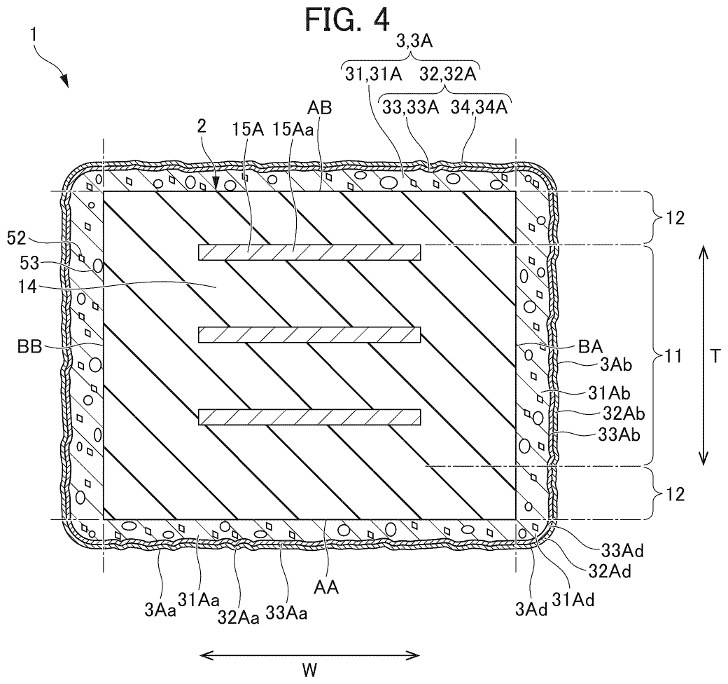

A cross section parallel or substantially parallel to the lamination direction T and the length direction L is referred to as an “LT cross section”. A cross section parallel or substantially parallel to the lamination direction T and the width direction W is referred to as a “WT cross section”. The cross section of FIG. 2 is an LT cross section passing through the middle portion in the width direction W of the multilayer ceramic capacitor 1. The cross section of FIG. 3 is a WT cross section passing through the middle portion in the length direction L of the multilayer ceramic capacitor 1. The cross section of FIG. 4 is a WT cross section passing through the middle portion in the length direction L of a portion of the first external electrode 3A that overlaps the first main surface AA as viewed in the lamination direction T.

### Multilayer Body 2

The multilayer body 2 includes an inner layer portion and a pair of outer layer portions 12 that sandwich the inner layer portion 11 in the lamination direction T. The multilayer body 2 preferably includes rounded corner portions and ridge portions. The corner portions each refer to a portion where the three surfaces of the multilayer body 2 intersect with one another. The ridge portions each refer to a portion where two surfaces of the multilayer body 2 intersect with each other.

The outer dimensions of the multilayer body are, for example, 0.2 mm or more and 5.7 mm or less in the length direction L, 0.1 mm or more and 5.0 mm or less in the width direction W, and 0.1 mm or more and 5.0 mm or less in the width direction W. The outer dimensions of the multilayer ceramic capacitor 1 can be measured by a micrometer.

### Inner Layer Portion 11

As illustrated in FIGS. 2 and 3, the inner layer portion 11 includes a plurality of dielectric layers 14 and a plurality of internal electrodes 15. The dielectric layers 14 and the internal electrodes 15 are alternately stacked or laminated.

Each of the dielectric layers 14 is made of a perovskite compound containing Ba or Ti. As a material constituting the dielectric layers 14, a dielectric ceramic mainly containing BaTiO₃, CaTiO₃, SrTiO₃, CaZrO₃, or the like can be used. In addition, a material in which a Mn compound, a Mg compound, a Si compound, a Fe compound, a Cr compound, a Co compound, a Ni compound, an Al compound, a V compound, a rare earth compound, or the like is added as a subcomponent to these main components may be used.

Each of the internal electrodes 15 is formed by sintering an electrically conductive paste containing a metal powder serving as an electrical conductor, an organic solvent, a binder, and a dispersant on the dielectric layer 14. As the metal powder to be an electrical conductor, for example, a metal such as Ni, Cu, Ag, Pd, an Ag—Pd alloy, or Au can be used. These metals may be compounds containing these metal elements or alloys with other metals.

The internal electrodes 15 include a plurality of first internal electrodes 15A and a plurality of second internal electrodes 15B. Each of the first internal electrodes 15A is exposed only at the first end surface CA. Each of the second internal electrodes 15B is exposed only at the second end surface CB. The first internal electrodes 15A and the second internal electrodes 15B are alternately provided.

Each of the first internal electrodes 15A includes a first counter portion 15Aa and a first extension portion 15Ab. The first counter portion 15Aa is a portion of the first internal electrode 15A opposed to the second internal electrode 15B adjacent in the lamination direction T. The first counter portion 15Aa is located at a middle portion between the end surfaces C. The first extension portion 15Ab is a portion of the first internal electrode 15A that extends from the first counter portion 15Aa toward the first end surface CA, and is exposed at the first end surface CA.

Each of the second internal electrodes 15B includes a second counter portion 15Ba and a second extension portion 15Bb. The second counter portion 15Ba is a portion of the second internal electrode 15B opposed to the adjacent first internal electrode 15A (first counter portion 15Aa). The second counter portion 15Ba is located at a middle portion between the end surfaces C. The second extension portion 15Bb is a portion of the second internal electrode 15B that extends from the second counter portion 15Ba toward the second end surface CB, and is exposed at the second end surface CB.

The first internal electrodes 15A and the second internal electrodes 15B may be collectively referred to as “internal electrode 15”. The first counter portions 15Aa and the second counter portions 15Ba may be collectively referred to as “counter portion 15a”.

### Outer Layer Portion 12

Each of the outer layer portions 12 is made of the same or substantially the same material as the dielectric layers 14 of the inner layer portion 11. The internal electrode 15 is not provided in the outer layer portions 12.

### External Electrode 3

The first external electrode 3A is provided on the first end surface CA. The first external electrode 3A covers not only the first end surface CA, but also a portion of the main surface A and a portion of the lateral surface B. The first external electrode 3A is connected to the first internal electrodes 15A. The first external electrode 3A includes a first base electrode layer 31A in contact with the surface of the multilayer body 2, and a first plated layer 32A provided on the first base electrode layer 31A. The first plated layer 32A includes a first lower plated layer 33A provided on the first base electrode layer 31A and a first upper plated layer 34A provided on the first lower plated layer 33A.

The second external electrode 3B is provided on the second end surface CB. The second external electrode 3B covers not only the second end surface CB, but also a portion of the main surface A and a portion of the lateral surface B. The second external electrode 3B is connected to the second internal electrodes 15B. The second external electrode 3B includes a second base electrode layer 31B in contact with the surface of the multilayer body 2, and a second plated layer 32B provided on the second base electrode layer 31B. The second plated layer 32B includes a second lower plated layer 33B provided on the second base electrode layer 31B and a second upper plated layer 34B provided on the second lower plated layer 33B.

The first base electrode layer 31A and the second base electrode layer 31B may be collectively referred to as “base electrode layer 31”. The first plated layer 32A and the second plated layer 32B may be collectively referred to as “plated layer 32”. The first lower plated layer 33A and the second lower plated layer 33B may be collectively referred to as “lower plated layer 33”. The first upper plated layer 34A and the second upper plated layer 34B may be collectively referred to as “upper plated layer 34”.

The base electrode layer 31 includes an electrically conductive metal, glass 52, and voids 53. The base electrode layer 31 is, for example, a fired layer. The electrically conductive metal is, for example, an appropriate metal such as Ni (nickel), Cu (copper), Ag (silver), Pd (palladium), Au (gold), or an Ag—Pd alloy, and is preferably Cu. The metal contained in the base electrode layer 31 can be confirmed by using a wavelength dispersion X-ray analyzer (WDX) after polishing the multilayer ceramic capacitor 1. The maximum thickness of the base electrode layer 31 is preferably 10 μm or more and 200 μm or less. The thickness of the base electrode layer 31 is reduced at the corner portions of the multilayer body 2. The glass 52 assumes the form of particles. The pieces of glass 52 and the voids 53 can be confirmed by using a scanning electron microscope (SEM) after polishing the multilayer ceramic capacitor 1.

The plated layer 32 is made of, for example, one metal selected from the group consisting of Ni, Cu, Ag, Pd, Au, and Sn, or an alloy containing this metal.

The lower plated layer 33 is, for example, a Ni plated layer. The upper plated layer 34 is, for example, a Sn (tin) plated layer. The thickness of the plated layer per layer is preferably 1.5 μm or more and 15.0 μm or less. The plated layer may be a single layer or may be a Cu plated layer or an Au plated layer.

When the multilayer ceramic capacitor 1 is mounted, the external electrodes 3 are connected to a substrate by solder. The multilayer ceramic capacitor 1 is mounted on the substrate in a direction in which the first main surface AA is opposed to the substrate.

Here, details of the first base electrode layer 31A will be described. Since the configuration of the second base electrode layer 31B is the same or substantially the same as that of the first base electrode layer 31A, the description thereof will be omitted.

As illustrated in FIGS. 2 and 4, the first external electrode 3A includes a first external electrode end surface region 3Ac which is a region overlapping the first end surface CA as viewed in the length direction L, a first external electrode main surface region 3Aa which is a region overlapping the first main surface AA as viewed in the lamination direction T, and a first external electrode corner region 3Ad which is a region connecting at least one of the first external electrode lateral surface region 3Ab or the first external electrode main surface region 3Aa to the first external electrode end surface region 3Ac.

The first base electrode layer 31A includes a first base electrode end surface region 31Ac which is a region overlapping the first end surface CA as viewed in the length direction L, a first base electrode main surface region 31Aa which is a region overlapping the first main surface AA as viewed in the lamination direction T, and a first base electrode corner region 31Ad which is a region connecting at least one of the first base electrode lateral surface region 31Ab or the first base electrode main surface region 31Aa to the first base electrode end surface region 31Ac.

The first plated layer 32A includes a first plated end surface region 32Ac which is a region overlapping the first end surface CA as viewed in the length direction L, a first plated main surface region 32Aa which is a region overlapping the first main surface AA as viewed in the lamination direction T, and a first plated corner region 32Ad which is a region connecting at least one of the first plated lateral surface region 32Ab or the first plated main surface region 32Aa to the first plated end surface region 32Ac.

The first lower plated layer 33A includes a first lower plated end surface region 33Ac which is a region overlapping the first end surface CA as viewed in the length direction L, a first lower plated main surface region 33Aa which is a region overlapping the first main surface AA as viewed in the lamination direction T, and a first lower plated corner region 33Ad which is a region connecting at least one of the first lower plated lateral surface region 33Ab or the first lower plated main surface region 33Aa to the first lower plated end surface region 33Ac.

The first lower plated layer 33A covers the entire outer surface of the first base electrode layer 31A. Therefore, the entire outer surface of the first base electrode end surface region 31Ac corresponds to a region of the outer surface of the first base electrode end surface region 31Ac opposed to the first plated layer 32A.

The first upper plated layer 34A covers the entire outer surface of the first lower plated layer 33A. The outer surface of the first upper plated layer 34A serves as the outer surface of the first external electrode 3A, and also serves as the outer surface of the first plated layer 32A.

### Surface Smoothness

The outer surface of the first base electrode end surface region 31Ac is smoother than the outer surface of the first base electrode main surface region 31Aa, and has, for example, a smaller surface roughness.

The outer surface of the first base electrode end surface region 31Ac is smoother than the outer surface of the first base electrode lateral surface region 31Ab, and has, for example, a smaller surface roughness.

The region of the outer surface of the first base electrode end surface region 31Ac that is opposed to the first plated layer 32A is smoother than any of the region of the outer surface of the first base electrode main surface region 31Aa that is opposed to the first plated layer 32A or the region of the outer surface of the first base electrode lateral surface region 31Ab that is opposed to the first plated layer 32A, and has, for example, a smaller surface roughness.

The outer surface of the first lower plated end surface region 33Ac is smoother than the outer surface of the first lower plated main surface region 33Aa, and has a smaller surface roughness, for example.

The outer surface of the first lower plated end surface region 33Ac is smoother than the outer surface of the first lower plated lateral surface region 33Ab, and has a smaller surface roughness, for example.

The surface roughness of the outer surface of the first lower plated end surface region 33Ac is 0 μm or more and 0.1 μm or less. The surface roughness of the outer surface of the first lower plated main surface region 33Aa and the surface roughness of the outer surface of the first lower plated lateral surface region 33Ab are greater than 0.1 μm and less than or equal to 0.4 μm, respectively. More preferably, the surface roughness of the outer surface of the first lower plated main surface region 33Aa and the surface roughness of the outer surface of the first lower plated lateral surface region 33Ab are greater than 0.1 μm and less than or equal to 0.4 μm, respectively.

The outer surface of the first base electrode corner region 31Ad is smoother than any of the outer surface of the first base electrode main surface region 31Aa or the outer surface of the first base electrode lateral surface region 31Ab, and has, for example, a smaller surface roughness.

The outer surface of the first lower plated corner region 33Ad is smoother than any of the outer surface of the first lower plated main surface region 33Aa or the outer surface of the first lower plated lateral surface region 33Ab, and has, for example, a smaller surface roughness.

A value obtained by dividing the surface roughness of the outer surface of the first lower plated end surface region 33Ac by a value obtained by averaging the surface roughness of the outer surface of the first lower plated main surface region 33Aa and the surface roughness of the outer surface of the first lower plated lateral surface region 33Ab is greater than 0 and equal to or less than 0.7. This allows the solder to sufficiently spread in the first external electrode end surface region 3Ac.

The surface roughness of the first base electrode layer 31A, the surface roughness of the first lower plated layer 33A, and the surface roughness of the first upper plated layer 34A are measured by acquiring an image of a measurement target with a laser microscope and analyzing the acquired image with analysis software. The surface roughness is defined as an arithmetic mean height Sa. The size of the acquired image is, for example, 280 μm×210 μm.

Prior to the measurement of the surface roughness of the first lower plated layer 33A, the first upper plated layer 34A is peeled off. The first upper plated layer 34A is peeled off by immersing the first external electrode 3A in a metal peeling liquid for a predetermined period of time. At this time, the metal stripping solution is appropriately stirred.

When the plated layer is a Sn plated layer, the metal stripping solution is, for example, ENSTRIP TL-105. The immersion time is, for example, 1.5 minutes to 9 minutes. Since the thickness of the lower plated layer is uniform or substantially uniform, if the surface roughness of the lower plated layer can be measured, the surface roughness of the base electrode layer can be measured.

In the LT cross section passing through the middle portion in the width direction W of the multilayer body 2, the ratio of the length of the line along the outer surface of the first base electrode end surface region 31Ac to the length of the line along the first end surface CA is smaller than the ratio of the length of the line along the outer surface of the first base electrode main surface region 31Aa to the length of the line along the portion of the first main surface AA where the first base electrode layer 31A is provided.

In the LT cross section passing through the middle portion in the width direction W of the multilayer body 2, when the ratio of the length of the line along the outer surface of the first base electrode end surface region 31Ac to the length of the line along the first end surface CA is defined as A1, and the ratio of the length along the outer surface of the first base electrode main surface region 31Aa to the length of the line along the portion of the first main surface AA in contact with the first base electrode main surface region 31Aa is defined as B1, the relationship between A1 and B1 satisfies 0.5≤A1/B1<1.

In the LT cross section passing through the middle portion in the width direction W of the multilayer body 2, a rectangular region having a side extending in parallel with the first main surface AA and a side extending in parallel with the first end surface CA and having the size of 75 μm×55 μm is referred to as a “reference region”. Each of the length of the line along the first end surface CA, the length of the line along the outer surface of the first base electrode end surface region 31Ac, the length of the line along the portion of the first main surface AA in contact with the first base electrode main surface region 31Aa, and the length along the outer surface of the first base electrode main surface region 31Aa is the length of the portion located in the reference region.

In addition, when the length of the line along the first end surface CA and the length of the line along the outer surface of the first base electrode end surface region 31Ac are acquired, the position of the reference region is defined as a position where the middle portion of the reference region in the lamination direction T overlaps with the middle portion of the first base electrode end surface region 31Ac in the lamination direction T. When the length of the line along the portion of the first main surface AA in contact with the first base electrode main surface region 31Aa and the length along the outer surface of the first base electrode main surface region 31Aa are acquired, the position of the reference region is defined as a position where the middle portion of the reference region in the length direction overlaps with the middle portion of the first base electrode main surface region 31Aa in the width direction W.

An image of the reference region is acquired by an optical microscope. In the acquired image, lengths of various lines are measured. The cross section of the multilayer ceramic capacitor 1 to be measured is exposed by polishing the multilayer ceramic capacitor 1.

Hardness of First Base Electrode Layer 31A The hardness Hv of the first base electrode end surface region 31Ac is higher than any of the hardness Hv of the first base electrode main surface region 31Aa or the hardness Hv of the first base electrode lateral surface region 31Ab.

The hardness Hv of the first base electrode end surface region 31Ac is 100 or more and 200 or less.

The hardness Hv of the first base electrode corner region 31Ad is higher than any of the hardness Hv of the first base electrode main surface region 31Aa or the hardness Hv of the first base electrode lateral surface region 31Ab.

The hardness Hv of each portion of the first base electrode layer 31A is measured using a microhardness meter in the multilayer ceramic capacitor 1 from which the first upper plated layer 34A is removed. The hardness Hv of each portion of the first base electrode layer 31A is defined as the hardness Hv of the outer surface of each portion of the first base electrode layer 31A. The hardness Hv of the outer surface of the first base electrode layer 31A is measured from above the first lower plated layer 33A in a state where the first lower plated layer 33A adheres to the first base electrode layer 31A. Since the thickness of the first lower plated layer 33A is extremely small, the influence of the first lower plated layer 33A on the measured value of the hardness Hv of the outer surface of the first base electrode layer 31A is small. However, the first upper plated layer 34A is removed in advance by the above-described method using a metal stripping solution.

### Manufacturing Method of Multilayer Ceramic Capacitor 1

Next, a method of manufacturing the multilayer ceramic capacitor 1 according to the exemplary embodiment will be described.

### Internal Electrode Pattern Forming Step

First, a ceramic green sheet including a sheet-shaped ceramic slurry is prepared. A pattern of the internal electrodes 15 is printed on the ceramic green sheet with an electrically conductive paste. Thus, ceramic green sheets to be laminated for manufacturing an inner layer portion in which the internal electrodes 15 are provided are obtained. The pattern of the internal electrodes 15 is formed by, for example, printing such as screen printing, gravure printing, or relief printing.

### Lamination Process

Next, the ceramic green sheets for manufacturing the inner layer portion are laminated. The ceramic green sheets for manufacturing the inner layer portion are laminated so that the internal electrode patterns are shifted by a half pitch in the length direction L between the adjacent sheets. Next, the ceramic green sheets for manufacturing the outer layer portion, which functions as the outer layer portion 12, are laminated on both sides of the laminated multilayer ceramic green sheets in the lamination direction T. The ceramic green sheet for manufacturing the outer layer portion is thermocompression-bonded to the ceramic green sheets to be laminated. Thus, a mother block is obtained.

Each of the outer layer portions 12 may be formed by laminating a plurality of ceramic green sheets, or may be made of a single ceramic green sheet. The ceramic green sheet for manufacturing the inner layer portion and the ceramic green sheet for manufacturing the outer layer portion may contain different components.

### Mother Block Cutting Process

Then, the mother block is divided along cutting lines depending on the dimensions of the multilayer body 2. The mother block is cut, for example, in the length direction L and the width direction W. As a result, a plurality of rectangular parallelepiped blocks (referred to as “multilayer chips”) are obtained. In addition, the corner portions and the ridge portions of each of the multilayer chips are preferably rounded by barrel polishing, for example.

### Multilayer Body Firing Step

Next, the multilayer chips are heated at a predetermined firing temperature in a nitrogen atmosphere for a predetermined period of time. Thus, the multilayer body 2 is obtained.

Base Electrode Layer Forming Step Next, the base electrode layer 31 is formed on each end surface C of the multilayer body 2. An electrically conductive paste containing glass and metal is applied onto the multilayer body 2. Each base electrode layer 31 is formed, for example, so as to cover each end surface C and a portion of each main surface A, a portion of each lateral surface B, and a portion of each ridge line 5 adjacent to the end surface C. However, the present disclosure is not limited thereto, and each base electrode layer 31 may be provided only on each end surface C.

### Base Electrode Layer Firing Step

Next, the multilayer body 2 on which the base electrode layer 31 is formed is heated at a predetermined firing temperature for a predetermined period of time in a nitrogen atmosphere. As a result, the base electrode layer 31 is fired on the multilayer body 2. The multilayer body firing step and the base electrode layer firing step may be performed simultaneously after the material of the base electrode layer 31 is provided on the multilayer chip. When the solvent or the like in the electrically conductive paste dissipates during firing, the voids 53 are formed in the base electrode layer 31.

### Pressing Step

Here, the outer surface of the first base electrode layer 31A is pressed by a pressing member. The pressing member is, for example, a metal plate. The pressing member is made of a material harder than the first base electrode layer 31A, and is preferably made of a material harder than Cu. Thus, the outer surface of the first base electrode layer 31A is smoothed. The first base electrode end surface region 31Ac is pressed by the pressing member more selectively than the first base electrode main surface region 31Aa or the first base electrode lateral surface region 31Ab. The first base electrode corner region 31Ad is pressed by the pressing member more selectively than the first base electrode main surface region 31Aa or the first base electrode lateral surface region 31Ab.

Thus, the outer surface of the first base electrode end surface region 31Ac and the outer surface of the first base electrode corner region 31Ad can be made smoother than the outer surface of the first base electrode main surface region 31Aa and the outer surface of the first base electrode lateral surface region 31Ab. The hardness of the outer surface of the first base electrode end surface region 31Ac and the hardness of the outer surface of the first base electrode corner region 31Ad can be made higher than the hardness of the outer surface of the first base electrode main surface region 31Aa and the hardness of the outer surface of the first base electrode lateral surface region 31Ab.

### Plating Step

Next, the first lower plated layer 33A is formed on the outer surface of the first base electrode layer 31A. Next, the first upper plated layer 34A is formed on the outer surface of the first lower plated layer 33A. The first lower plated layer 33A is formed by, for example, Ni plating. The first upper plated layer 34A is formed by, for example, Sn plating. The first lower plated layer 33A and the first upper plated layer 34A are sequentially formed by, for example, an electrolytic plating method. Thus, the first external electrodes 3A are formed on the first end surfaces CA, respectively.

The thickness of the first lower plated layer 33A is relatively small. Therefore, the shape of the outer surface of the first lower plated layer 33A is substantially the same as the shape of the outer surface of the first base electrode layer 31A. Therefore, the outer surface of the first lower plated end surface region 33Ac and the outer surface of the first lower plated corner region 33Ad are smoother than the outer surface of the first lower plated main surface region 33Aa and the outer surface of the first lower plated lateral surface region 33Ab.

The thickness of the first upper plated layer 34A is relatively small. Therefore, the shape of the outer surface of the first upper plated layer 34A is substantially the same as the shape of the outer surfaces of the first base electrode layer 31A or the first lower plated layer 33A. Therefore, the outer surface of the first external electrode end surface region 3Ac and the outer surface of the first external electrode corner region 3Ad are smoother than the outer surface of the first external electrode main surface region 3Aa and the outer surface of the first external electrode lateral surface region 3Ab.

The pressing step and the plating step are similarly performed on the second base electrode layer 31B.

Thus, the multilayer ceramic capacitor 1 shown in FIG. 1 is obtained.

### Advantageous Effects According to First Exemplary Embodiment

According to the present exemplary embodiment, it is possible to obtain the following advantageous effects.

According to the present exemplary embodiment, the outer surface of the first base electrode end surface region 31Ac is smoother than the outer surface of the first base electrode main surface region 31Aa.

According to such a configuration, since the outer surface of the region on the end surface of the first external electrode 3A can be made smooth, it is possible to favorably spread the solder to the region on the end surface of the first external electrode 3A.

In addition, it is possible to roughen the outer surface of the region on the first main surface AA of the first external electrode 3A. With such a configuration, it is possible to generate an anchor effect between the solder and the portion of the first external electrode 3A opposed to the substrate, such that it is possible to improve the bonding property between the solder and the multilayer ceramic capacitor 1.

Therefore, it is possible to provide multilayer ceramic capacitors each having excellent reliability.

According to the present exemplary embodiment, the outer surface of the first base electrode end surface region 31Ac is smoother than the outer surface of the first base electrode lateral surface region 31Ab.

According to this configuration, it is possible to relatively roughen the outer surface of the region on the first lateral surface BA of the first external electrode 3A. As a result, it is possible to generate an anchor effect between the solder and the region on the first lateral surface BA of the first external electrode 3A, such that it is possible to further improve the bonding property between the solder and the multilayer ceramic capacitor 1.

According to the present exemplary embodiment, the region of the outer surface of the first base electrode end surface region 31Ac opposed to the first plated layer 32A is smoother than any of the region of the outer surface of the first base electrode main surface region 31Aa opposed to the first plated layer 32A or the region of the outer surface of the first base electrode lateral surface region 31Ab opposed to the first plated layer 32A.

According to such a configuration, the shape of the outer surface of the first base electrode layer 31A is reflected on the outer surface of the first plated layer 32A. Therefore, in the configuration in which the first plated layer 32A is provided on the first base electrode layer 31A, it is possible to improve the spreading of the solder to the region on the first end surface CA of the first external electrode 3A, and to generate an anchor effect between the first external electrode 3A and the solder.

According to the present exemplary embodiment, the outer surface of the first lower plated end surface region 33Ac is smoother than the outer surface of the first lower plated main surface region 33Aa.

According to such a configuration, the shape of the outer surface of the first base electrode layer 31A and the shape of the outer surface of the first lower plated layer 33A are reflected on the outer surface of the first upper plated layer 34A. Therefore, in the configuration in which the first lower plated layer 33A and the first upper plated layer 34A are provided on the first base electrode layer 31A, it is possible to improve the spreading of the solder to the region on the first end surface CA of the first external electrode 3A, and to generate an anchor effect between the first external electrode 3A and the solder.

According to the present exemplary embodiment, the outer surface of the first lower plated end surface region 33Ac is smoother than the outer surface of the first lower plated lateral surface region 33Ab.

According to such a configuration, the shape of the outer surface of the first base electrode layer 31A and the shape of the outer surface of the first lower plated layer 33A are reflected on the outer surface of the first upper plated layer 34A. Therefore, in the configuration in which the first lower plated layer 33A and the first upper plated layer 34A are provided on the first base electrode layer 31A, it is possible to improve the spreading of the solder to the region on the first end surface CA of the first external electrode 3A, and to generate the anchor effect between the first external electrode 3A and the solder over a wider range.

According to the present exemplary embodiment, the surface roughness of the outer surface of the first lower plated end surface region 33Ac is 0 μm or more and 0.1 μm or less, and the surface roughness of the outer surface of the first lower plated main surface region 33Aa and the surface roughness of the outer surface of the first lower plated lateral surface region 33Ab are greater than 0.1 μm and 0.4 μm or less, respectively.

According to such a configuration, it is possible to favorably improve the spreading of the solder to the region on the first end surface CA of the first external electrode 3A, and to generate the anchor effect between the first external electrode 3A and the solder.

According to the present exemplary embodiment, the outer surface of the first base electrode corner region 31Ad is smoother than any of the outer surface of the first base electrode main surface region 31Aa or the outer surface of the first base electrode lateral surface region 31Ab.

According to such a configuration, it is possible to make smoother the outer surface of the region between the region of the first external electrode 3A opposed to the substrate and the region on the first end surface CA. This makes it possible to favorably spread the solder to the region on the first end surface CA of the first external electrode 3A.

In addition, it is possible to roughen the outer surface of the region on the first main surface AA of the first external electrode 3A. As a result, since it is possible to generate an anchor effect between the solder and the portion of the first external electrode 3A opposed to the substrate, it is possible to improve the bonding property between the solder and the multilayer ceramic capacitor 1.

According to the present exemplary embodiment, the outer surface of the first lower plated corner region 33Ad is smoother than any of the outer surface of the first lower plated main surface region 33Aa or the outer surface of the first lower plated lateral surface region 33Ab.

According to such a configuration, the shape of the outer surface of the first base electrode layer 31A is reflected on the outer surface of the first plated layer 32A. Therefore, in the configuration in which the first plated layer 32A is provided on the first base electrode layer 31A, it is possible to favorably improve the spreading of the solder to the region on the first end surface CA of the first external electrode 3A, and to generate an anchor effect between the first external electrode 3A and the solder.

According to the present exemplary embodiment, in the cross section extending parallel or substantially parallel to the lamination direction T and the length direction L and passing through the middle portion in the width direction W of the multilayer body 2, the ratio of the length of the line along the outer surface of the first base electrode end surface region 31Ac to the length of the line along the first end surface CA is smaller than the ratio of the length of the line along the outer surface of the first base electrode main surface region 31Aa to the length of the line along the portion of the first main surface AA where the first base electrode layer 31A is provided.

According to such a configuration, it is possible to favorably improve spreading of the solder to the region on the first end surface CA of the first external electrode 3A, and to generate an anchor effect between the first external electrode 3A and the solder. Therefore, it is possible to provide the multilayer ceramic capacitors 1, each having excellent reliability.

According to the present exemplary embodiment, in the cross section extending parallel or substantially parallel to the lamination direction T and the length direction L and passing through the middle portion in the width direction W of the multilayer body 2, when the ratio of the length of the line along the surface of the first base electrode end surface region 31Ac to the length of the line along the first end surface CA is defined as A1, and the ratio of the length along the outer surface of the first base electrode main surface region 31Aa to the length of the line along the portion of the first main surface AA in contact with the first base electrode main surface region 31Aa is defined as B1, the relationship between A1 and B1 satisfies 0.5≤A1/B1<1.

According to such a configuration, it is possible to more reliably improve the spreading of the solder to the region on the first end surface CA of the first external electrode 3A, and to generate the anchor effect between the first external electrode 3A and the solder.

According to the present exemplary embodiment, the hardness Hv of the first base electrode end surface region 31Ac is higher than any of the hardness Hv of the first base electrode main surface region 31Aa or the hardness Hv of the first base electrode lateral surface region 31Ab.

As the hardness of the first base electrode layer 31A is higher, the first base electrode layer 31A can be made denser, such that it is possible to suitably reduce or prevent the permeation of water into the first base electrode layer 31A. According to such a configuration, since it is possible to increase the hardness Hv of the first base electrode end surface region 31Ac, it is possible to reduce or prevent water from entering the multilayer body 2 through the first end surface CA.

In addition, as the hardness Hv of the first base electrode layer 31A is lower, it is possible to reduce tightening of the multilayer body 2, such that it is possible to reduce or prevent the occurrence of cracks in the multilayer body 2.

Therefore, it is possible to provide the multilayer ceramic capacitors 1 each having excellent reliability.

According to the present exemplary embodiment, the hardness Hv of the first base electrode end surface region 31Ac is 100 or more and 200 or less.

According to such a configuration, since it is possible to make the first base electrode layer 31A dense, it is possible to more reliably reduce or prevent the intrusion of water into the first end surface CA.

According to such a configuration, as the hardness of the base electrode layer 31 is lower, the tightening of the multilayer body 2 by the base electrode layer 31 is weaker. Accordingly, since it is possible to reduce the tightening of the multilayer body 2 by the first base electrode main surface region 31Aa, it is possible to reduce or prevent the generation of cracks in the multilayer body 2 due to stress.

According to the present exemplary embodiment, the hardness Hy of the first base electrode corner region is higher than any of the hardness Hv of the first base electrode main surface region or the hardness Hv of the first base electrode lateral surface region.

According to such a configuration, by increasing the hardness of the first base electrode corner region 31Ad and densifying the first base electrode corner region 31Ad, it is possible to reduce or prevent the intrusion of water into the multilayer body 2 through the ridge portions of the multilayer body 2. In addition, since it is possible to lower the hardness of the first base electrode main surface region 31Aa and the first base electrode lateral surface region 31Ab, it is possible to reduce the tightening of the multilayer body 2 by the first base electrode main surface region 31Aa and the first base electrode lateral surface region 31Ab.

### Second Exemplary Embodiment

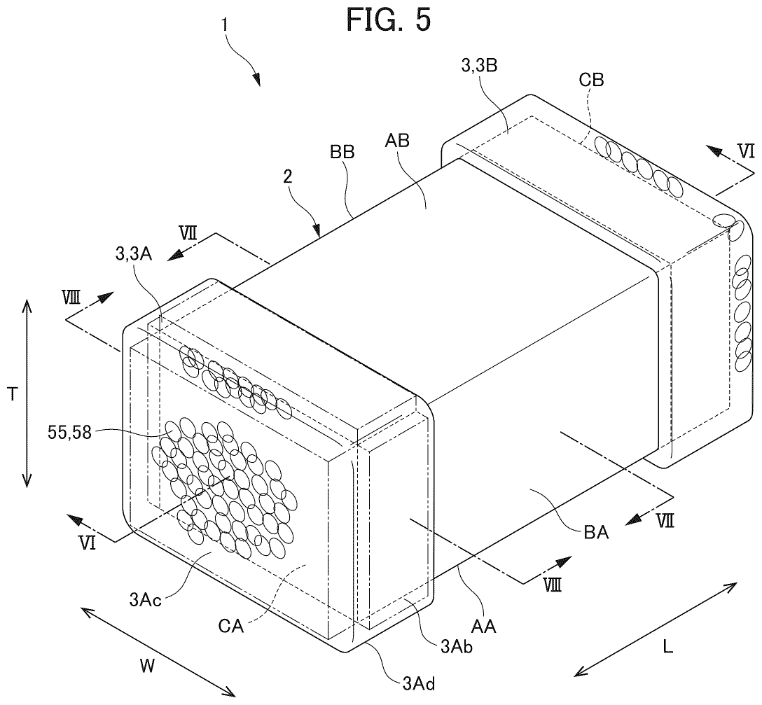

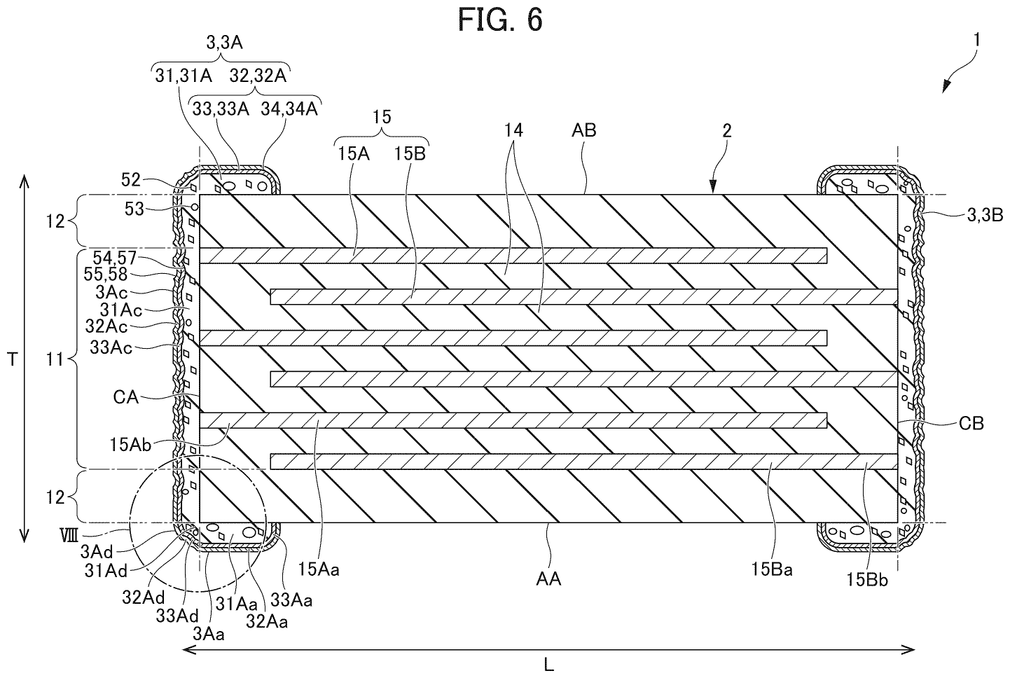

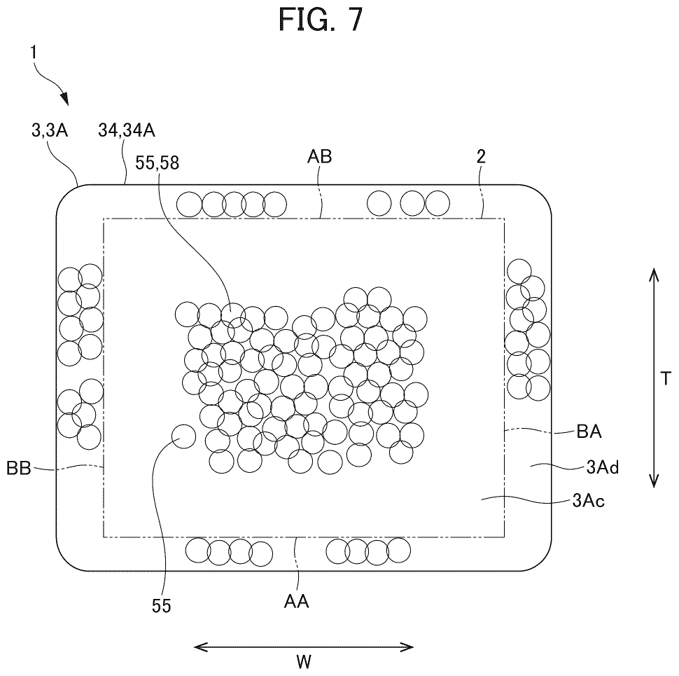

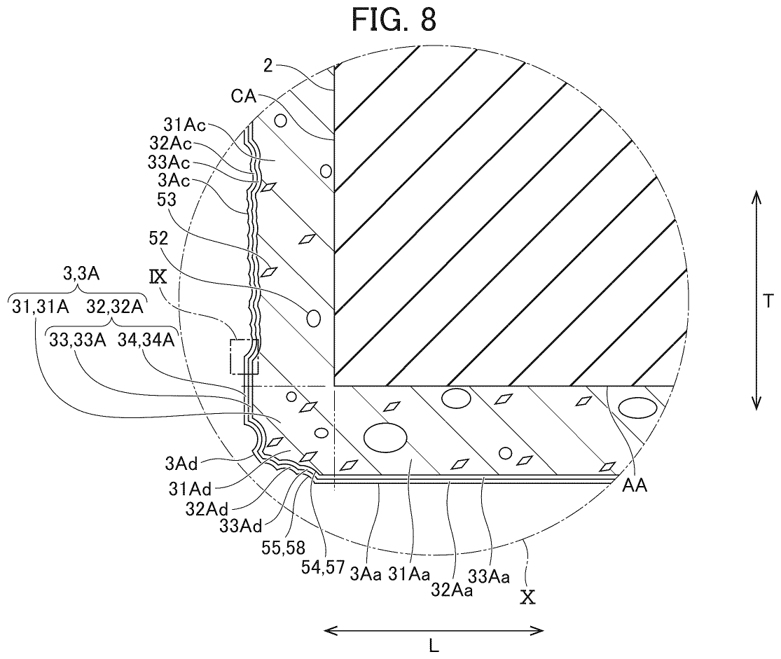

Next, a multilayer ceramic capacitor according to a second exemplary embodiment of the present disclosure will be described with reference to FIGS. 5 to 9. Hereinafter, differences from the first exemplary embodiment will be mainly described, and the same or substantially the same components as those of the first exemplary embodiment will be denoted by the same reference numerals and descriptions thereof will be omitted. In addition, the cross section in FIG. 6 is an LT cross section passing through the middle portion in the width direction W of the multilayer ceramic capacitor 1.

### Recessed Portion 55

As shown in FIGS. 5 to 9, in the second exemplary embodiment, the surface of the first plated layer 32A (specifically, the surface of the first upper plated layer 34A) is provided with a plurality of recessed portions 55 that are indented toward the multilayer body 2 from the surface of the first plated layer 32A, and a recessed region 58 that is a region provided by the recessed portions 55 adjacent to one another. On the surface of the first base electrode layer 31A, a plurality of recessed portions 54 and a recessed region 57 which is a region formed by the recessed portions 54 adjacent to one another are provided. The recessed portions 55 and the recessed region 58 of the first plated layer 32A are provided by indenting the first plated layer 32A (specifically, the first lower plated layer 33A and the first upper plated layer 34A) in accordance with the shapes of the recessed portions 54 and the recessed region 57 of the first base electrode layer 31A.

The plurality of recessed portions 55 and the recessed region 58 are provided in the first plated end surface region 32Ac. The recessed portions 55 and the recessed region 58 are not provided in the first plated main surface region 32Aa. The recessed portions 55 and the recessed region 58 are not provided in the first plated lateral surface region 32Ab.

The sum of the areas of the recessed portions 55 and the area of the recessed region 58 in the first plated end surface region 32Ac is greater than any of the sum of the areas of the recessed portions 55 and the area of the recessed region 58 in the first plated main surface region 32Aa or the sum of the areas of the recessed portions 55 and the area of the recessed region 58 in the first plated lateral surface region 32Ab. The number of the recessed portions 55 provided in the first plated end surface region 32Ac is larger than any of the number of the recessed portions 55 provided in the first plated main surface region 32Aa or the number of the recessed portions 55 provided in the first plated lateral surface region 32Ab.

The plurality of recessed portions 55 and the recessed region 58 are provided in the first plated corner region 32Ad.

The sum of the areas of the recessed portions 55 and the area of the recessed region 58 in the first plated corner region 32Ad is greater than any of the sum of the areas of the recessed portions 55 and the area of the recessed region 58 in the first plated main surface region 32Aa or the sum of the areas of the recessed portions 55 and the area of the recessed region 58 in the first plated lateral surface region 32Ab. The number of the recessed portions 55 provided in the first plated corner region 32Ad is larger than any of the number of the recessed portions 55 provided in the first plated main surface region 32Aa or the number of the recessed portions 55 provided in the first plated lateral surface region 32Ab.

The areas of the recessed portions 55 and the area of the recessed region 58 are measured by acquiring an image of a measurement target with a laser microscope and analyzing the acquired image with analysis software. Next, for each of the first plated end surface region 32Ac, the first plated main surface region 32Aa, the first plated lateral surface region 32Ab, and the first plated corner region 32Ad, the value of the areas of the recessed portions 55 is summed. The imaging direction of the first plated end surface region 32Ac is defined as the length direction L. The imaging direction of the first plated main surface region 32Aa is defined as the lamination direction T. The imaging direction of the first plated lateral surface region 32Ab is defined as the width direction W. The imaging direction of the first plated corner region 32Ad is defined as a direction in which a straight line extends which passes through an intersection between a tangent line of the first end surface CA parallel or substantially parallel to the lamination direction T and a tangent line of the first main surface AA parallel or substantially parallel to the length direction L and an intersection between a tangent line of the second end surface CB parallel or substantially parallel to the lamination direction T and a tangent line of the second main surface AB parallel or substantially parallel to the length direction L.

When viewed in the direction in which each of the recessed portions 55 is recessed (specifically, in the length direction L), each of the recessed portions 55 has, for example, a circular shape or a circular shape having a missing portion. A portion of an opening peripheral edge portion of each of the recessed portions 55 has an arc shape. The opening peripheral edge portion of each of the recessed portions 55 has, for example, an annular shape. The radius (in other words, the radius of curvature of the circular arc) of the circular ring including the circular arc formed by the opening peripheral edge portion of each of the recessed portions 55 is 5 μm or more, and preferably 5 μm or more and 100 μm or less. The radius of the circular ring formed by the opening peripheral edge portion of each of the recessed portions 55 is 5 μm or more, and preferably 5 μm or more and 100 μm or less.

The shape of the inner peripheral surface of each of the recessed portions 55 in a cross section of the recessed portion 55 extending in a direction in which the recessed portion 55 is recessed is an arc shape.

In addition, “a cross section of the recessed portion 55 extending in a direction in which the recessed portion 55 is recessed” is defined as, for example, an LT cross section when the recessed portion 55 is provided in the first base electrode end surface region 31Ac, and is defined as, for example, a WT cross section when the recessed portion 55 is provided in any of the first base electrode main surface region 31Aa, the first base electrode lateral surface region 31Ab, and the first base electrode corner region 31Ad.

The plurality of recessed portions 55 and the recessed region 58 are provided in the first plated corner region 32Ad.

Glass 52 Covered with Metal Thin Film 56

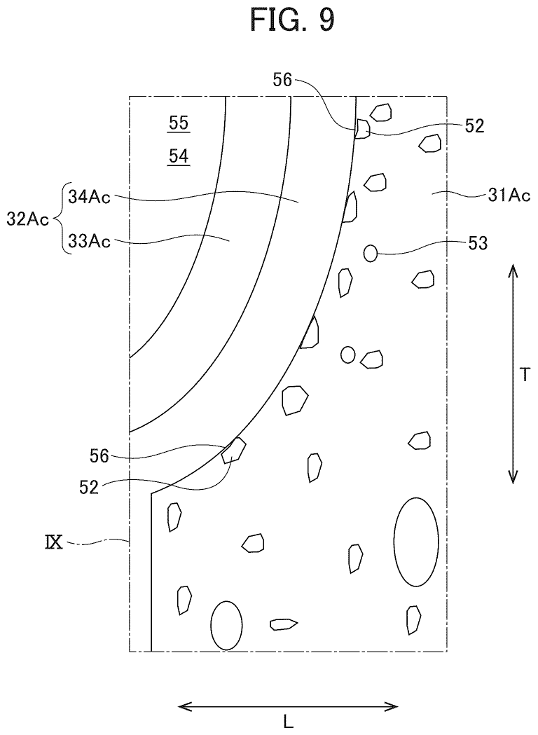

As shown in FIG. 9, the first base electrode layer 31A includes a plurality of pieces of glass 52 assuming particulate form. The first base electrode layer 31A includes metal thin films 56 each of which is a region between each of the pieces of glass 52 and the first plated layer 32A (specifically, the first lower plated layer 33A) and each of which is a region including an electrically conductive metal and having a thickness of 1 μm or less. In other words, the portion of each of the pieces of glass 52 adjacent to the first plated layer 32A is covered with the metal thin film 56 which includes metal and has a thin film shape. In addition, the thickness of the metal thin film 56 refers to the shortest distance between the portion of the metal thin film 56 in contact with each of the pieces of glass 52 and the portion in contact with the first plated layer 32A.

The electrically conductive metal having the highest content ratio among the electrically conductive metals included in the first base electrode layer 31A is, for example, Cu. The metal thin film 56 includes an electrically conductive metal having the highest content ratio among the electrically conductive metals included in the first base electrode layer 31A, and specifically, includes Cu.

Each of the pieces of glass 52 covered with the metal thin film 56 is exposed on the outer surface of the first base electrode layer 31A. Each of the pieces of glass 52 covered with the metal thin film 56 is in contact with the first lower plated layer 33A.

The first base electrode end surface region 31Ac includes each of the pieces of glass 52 covered with the metal thin film 56. Each of the pieces of glass 52 covered with the metal thin film 56 is exposed on the outer surface of the first base electrode end surface region 31Ac. Each of the pieces of glass 52 covered with the metal thin film 56 is in contact with the first lower plated end surface region 33Ac.

The first base electrode corner region 31Ad includes the pieces of glass 52 covered with the metal thin film 56. Each of the pieces of glass 52 covered with the metal thin film 56 is exposed on the outer surface of the first base electrode corner region 31Ad. Each of the pieces of glass 52 covered with the metal thin film 56 is in contact with the first lower plated corner region 33Ad.

### Manufacturing Method of Multilayer Ceramic Capacitor 1

Next, a method of manufacturing the multilayer ceramic capacitor 1 according to the second exemplary embodiment will be described. Differences from the method of manufacturing the multilayer ceramic capacitor 1 of the first exemplary embodiment will be described.

In the second exemplary embodiment, in the pressing step, a pressing member includes a curved surface. When the outer surface of the first base electrode layer 31A is pressed by the pressing member, a substantially hemispherical recess is formed on the outer surface of the first base electrode layer 31A. Thus, the recessed portion 54 is formed on the outer surface of the first base electrode layer 31A. When the position of the first base electrode layer 31A overlapping with the recessed portion 54 is pressed by the pressing member, a recessed region 57 is formed in the first base electrode layer 31A. The first base electrode end surface region 31Ac is pressed by a larger number of pressing members than the first base electrode main surface region 31Aa and the first base electrode lateral surface region 31Ab. The first base electrode corner region 31Ad is pressed by a larger number of pressing members than the first base electrode main surface region 31Aa and the first base electrode lateral surface region 31Ab. With such a configuration, a larger number of recessed portions 54 are formed on the outer surface of the first base electrode end surface region 31Ac and the outer surface of the first base electrode corner region 31Ad, than on the outer surface of the first base electrode main surface region 31Aa and the outer surface of the first base electrode lateral surface region 31Ab.

The first base electrode layer 31A is pressed by the pressing members to be pressed and compacted. The hardness of the first base electrode end surface region 31Ac is higher than the hardness of the first base electrode main surface region 31Aa.

When the first base electrode layer 31A is pressed by the pressing members, the first base electrode layer 31A is compressed. Thus, a region of the first base electrode layer 31A between the pieces of glass 52 and the first plated layer 32A is formed in a thin film shape. When the first base electrode layer 31A is pressed by the pressing members, the electrically conductive metal in the first base electrode layer 31A is rolled, such that the electrically conductive metal present in the vicinity of each of the pieces of glass 52 extends to a region between each of the pieces of glass 52 and the first plated layer 32A. Therefore, the mass ratio of the electrically conductive metal to the dielectric component in the metal thin film 56 is larger than the mass ratio of the electrically conductive metal to the dielectric component in the metal thin film 56 in a portion of the first base electrode layer 31A excluding the metal thin film 56. With such a configuration, the metal thin film 56 is formed between each of the pieces of glass 52 and the first plated layer 32A.

When the first base electrode layer 31A is pressed by the pressing members, there is a risk of each of the pieces of glass 52 being exposed on the outer surface of the first base electrode layer 31A. However, by the metal thin film 56 being provided between each of the pieces of glass 52 and the first plated layer 32A, it is possible to reduce or prevent the exposure of each of the pieces of glass 52.

Next, when the plating step is performed, the outer surface of the first lower plated layer 33A and the outer surface of the first upper plated layer 34A are in a state in which the shape of the outer surface of the first base electrode layer 31A is reflected. The recessed portions 55 and the recessed region 58 are formed on the outer surface of the first plated layer 32A (specifically, the outer surface of the first upper plated layer 34A).

### Advantageous Effects According to Second Exemplary Embodiment

According to the present exemplary embodiment, it is possible to obtain the following advantageous effects.

According to the present exemplary embodiment, the plurality of recessed portions 55 that are indented toward the multilayer body 2 from the surface of the first plated layer 32A and the recessed region 58 that is a region formed by the adjacent recessed portions 55 are provided on the surface of the first plated layer 32A.

According to such a configuration, it is possible to provide the recessed portions 55 and the recessed region 58 on the outer surface of the first external electrode 3A. It is possible for the recessed portions 55 and the recessed region 58 to trap solder on the first external electrode 3A. With such a configuration, it is possible to increase the fixing force between the first external electrode 3A and the solder at the time of mounting.

Therefore, it is possible to provide the multilayer ceramic capacitors 1, each having excellent reliability.

According to the present exemplary embodiment, the sum of the area of the recessed portions 55 and the area of the recessed region 58 in the first plated end surface region 32Ac is larger than any of the sum of the area of the recessed portions 55 and the area of the recessed region 58 in the first plated main surface region 32Aa or the sum of the area of the recessed portions 55 and the area of the recessed region 58 in the first plated lateral surface region 32Ab.

According to such a configuration, since it is possible to provide the recessed portions 55 and the recessed region 58 over a wider range in the first plated end surface region 32Ac, it is possible to increase the fixing force between the first plated end surface region 32Ac and the solder at the time of mounting.

The recessed portions 55 are formed by pressing the first external electrode 3A with the pressing members. Therefore, the region between the recessed portions 54 and the recessed region 57 in the first base electrode layer 31A, and the multilayer body 2 is pressed, compacted, and densified. When the first base electrode layer 31A is densely formed, water is less likely to permeate through the first base electrode layer 31A.

According to such a configuration, it is possible to provide the recessed portions 55 and the recessed region 58 over a wider range in the first plated end surface region 32Ac. With such a configuration, since it is possible to press and compact the first base electrode layer 31A over a wider range, it is possible to more reliably reduce or prevent the intrusion of water into the multilayer body 2 through the first end surface CA.

According to such a configuration, it is possible to reduce the range in which the recessed portions 55 and the recessed region 58 are provided in the first plated main surface region 32Aa and the range in which the recessed portions 55 and the recessed region 58 are provided in the first plated lateral surface region 32Ab. With such a configuration, it is possible to reduce the range in which the first base electrode main surface region 31Aa and the first base electrode lateral surface region 31Ab are pressed and compacted. Therefore, it is possible for the multilayer body 2 to be prevented from being tightened by the first base electrode main surface region 31Aa and the first base electrode lateral surface region 31Ab. Therefore, it is possible to reduce or prevent the occurrence of cracks in the multilayer body 2 due to stress.

According to the present exemplary embodiment, in the first plated end surface region 32Ac, a portion of the opening peripheral edge portion of each of the recessed portions 55 has an arc shape.

According to such a configuration, since it is possible for the solder to be suitably trapped by the recessed portions 55, it is possible to improve the fixing force between the first external electrode 3A and the solder at the time of mounting.

According to the present exemplary embodiment, in the first plated end surface region 32Ac, the radius of curvature of the arc formed by the opening peripheral edge portion of each of the recessed portions 55 is 5 μm or more, and preferably 5 μm or more and 100 μm or less.

According to such a configuration, since it is possible for the solder to be more suitably trapped by the recessed portions 55, it is possible to further improve the fixing force between the first external electrode 3A and the solder at the time of mounting.

According to the present exemplary embodiment, the recessed portions 55 and the recessed region 58 are provided in the first plated corner region 32Ad.

According to such a configuration, it is possible to increase the fixing force between the first plated corner region 32Ad and the solder at the time of mounting.

In addition, it is possible to prevent the multilayer body 2 from being tightened by the portion of the first base electrode layer 31A overlapping the first plated main surface region 32Aa or the first plated lateral surface region 32Ab. With such a configuration, it is possible to reduce or prevent the occurrence of cracks in the multilayer body 2 due to stress.

According to the present exemplary embodiment, the first plated layer 32A includes the first lower plated layer 33A in contact with the first base electrode layer 31A, and the first lower plated layer 33A is a Ni plated layer.

According to such a configuration, it is possible to reduce or prevent the erosion of the multilayer ceramic capacitor 1 by solder at the time of mounting. By the recessed portions 55 being provided on the outer surface of the first base electrode layer 31A, it is possible to more reliably attach the Ni plated layer to the first base electrode layer 31A, such that it is possible to more reliably reduce or prevent the erosion of the multilayer ceramic capacitor 1 due to solder.

According to the present exemplary embodiment, the first base electrode layer 31A includes the metal thin film 56, which is a region between the pieces of glass 52 and the first plated layer 32A, and includes the electrically conductive metal and has a thickness of 1 μm or less. The first base electrode layer 31A includes an electrically conductive metal and the pieces of glass 52, and each of the pieces of glass 52 is covered with the metal thin film 56 which is a thin film metal.

Each of the pieces of glass 52 included in the first base electrode layer 31A may be exposed on the surface of the first base electrode layer 31A. In this case, since it is difficult for plating to be formed on each of the pieces of glass 52, when a plated layer is formed on the first base electrode layer 31A, the plating may not adhere well to the first base electrode layer 31A. According to such a configuration, each of the pieces of glass 52 is covered with the metal thin film 56 which is a thin film metal. Since the metal thin film 56 contains a metal component, plating can be suitably adhered. Therefore, it is possible to suitably adhere plating onto each of the pieces of glass 52 covered with the metal thin film 56. With such a configuration, it is possible to continuously form a plated layer on the first base electrode layer 31A. Therefore, it is possible to suitably reduce or prevent the erosion of the multilayer ceramic capacitor 1 due to solder at the time of mounting, the intrusion of water into the multilayer body 2, and the like.

According to the present exemplary embodiment, the metal thin film 56 includes the electrically conductive metal having the highest content ratio among the electrically conductive metals included in the first base electrode layer 31A.

According to this configuration, it is possible to easily obtain each of the pieces of glass 52 covered with the metal thin film 56.

According to the present exemplary embodiment, the first base electrode end surface region 31Ac includes each of the pieces of glass 52 covered with the metal thin film 56.

According to such a configuration, it is possible to easily form a plated layer continuously on the first base electrode end surface region 31Ac. Therefore, it is possible to suitably reduce or prevent the erosion of the multilayer ceramic capacitor 1 due to solder at the time of mounting, the intrusion of water into the multilayer body 2, and the like.

According to the present exemplary embodiment, the first base electrode corner region 31Ad includes each of the pieces of glass 52 covered with the metal thin film 56.

In the first base electrode corner region 31Ad, since the thickness of the first base electrode layer 31A is relatively small, applying plating thereto is difficult. According to such a configuration, it is possible to continuously form the plated layer on the first base electrode corner region 31Ad.

Although exemplary embodiments of the present disclosure have been described above, the present disclosure is not limited to the above-described exemplary embodiments, and various changes and modifications thereto can be made.

The configuration of the multilayer ceramic capacitor 1 is not limited to the configurations shown in FIGS. 1 to 12. For example, the multilayer ceramic capacitor may be of a three-terminal type including a pair of external electrodes provided on each end surface and a pair of external electrodes provided on each lateral surface. In this case, the external electrodes provided on the lateral surfaces extend, for example, not only on the lateral surfaces, but also on the main surfaces. Similar to the external electrodes 3 of the above-described exemplary embodiments, the external electrode provided on each lateral surface includes a base electrode layer and plated layers (for example, a lower plated layer and an upper plated layer).

Also in the three-terminal multilayer ceramic capacitor, the external electrodes provided in a pair on both end surfaces have the same or substantially the same configuration as that of the external electrodes 3 of the above-described exemplary embodiments, such that it is possible to obtain desired advantageous effects.

Further, by making the configuration of the external electrode provided on each lateral surface correspond to the configuration of the external electrodes provided on the end surfaces in each of the above-described exemplary embodiments, it is possible to obtain the same or substantially the same advantageous effect as each of the above-described exemplary embodiments for the external electrode provided on each lateral surface. For example, in a portion of the base electrode layer or the plated layer provided on each lateral surface overlapping the lateral surface as viewed in the width direction, it is possible to favorably spread the solder by smoothening the surface to reduce the roughness, or increasing the number of recessed portions. It is possible to enhance the reliability in relation to moisture resistance by increasing the hardness of a portion of the base electrode layer provided on each lateral surface that overlaps the lateral surface as viewed in the width direction. It is possible to reduce or prevent the tightening of the multilayer body by lowering the hardness of a portion of the base electrode layer or the plated layer provided on each lateral surface that overlaps the main surface as viewed in the lamination direction.

In addition, in the pressing step, it is not necessarily essential for the external electrode provided on each lateral surface to be pressed by the pressing members.

In the second exemplary embodiment, the recessed portions 55 and the recessed region 58 are provided only in the first plated end surface region 32Ac and the first plated corner region 32Ad, but are not limited thereto. The recessed portions 55 and the recessed region 58 may be provided in the first plated main surface region 32Aa or may be provided in the first plated lateral surface region 32Ab.

However, it is preferable that the sum of the area of the recessed portions 55 and the area of the recessed region 58 in the first plated end surface region 32Ac is larger than any of the sum of the area of the recessed portions 55 and the area of the recessed region 58 in the first plated main surface region 32Aa or the sum of the area of the recessed portions 55 and the area of the recessed region 58 in the first plated lateral surface region 32Ab. It is preferable that the number of the recessed portions 55 provided in the first plated end surface region 32Ac is larger than any of the number of the recessed portions 55 provided in the first plated main surface region 32Aa or the number of the recessed portions 55 provided in the first plated lateral surface region 32Ab.

In addition, it is possible to appropriately replace the constituent elements in the above-described exemplary embodiments with well-known constituent elements, and the above-described exemplary embodiments may be appropriately combined, without departing from the gist of the present disclosure.

For example, the multilayer ceramic capacitor 1 of the first exemplary embodiment may further include the configuration of the multilayer ceramic capacitor 1 of the second exemplary embodiment. The multilayer ceramic capacitor 1 of the second exemplary embodiment may further include the configuration of the multilayer ceramic capacitor 1 of the first exemplary embodiment. The multilayer ceramic capacitor may include at least a portion of the configuration of the multilayer ceramic capacitor 1 of the first exemplary embodiment and at least a portion of the configuration of the multilayer ceramic capacitor 1 of the second exemplary embodiment. For example, in the multilayer ceramic capacitor 1 of the first exemplary embodiment, the recessed portions 55 may be provided in the external electrode 3, or the metal thin film 56 may be provided between each of the pieces of glass 52 and the first plated layer 32A.

More specifically, in the multilayer ceramic capacitor 1, the outer surface of the first base electrode end surface region 31Ac is smoother than the outer surface of the first base electrode main surface region 31Aa; in a cross section extending in parallel or substantially parallel with the lamination direction T and the length direction L and passing through the middle portion in the width direction W of the multilayer body 2, the ratio of the length of the line along the outer surface of the first base electrode end surface region 31Ac to the length of the line along the first end surface CA is smaller than the ratio of the length of the line along the outer surface of the first base electrode main surface region 31Aa to the length of the line along the portion of the first main surface AA where the first base electrode layer 31A is provided; the hardness Hv of the first base electrode end surface region 31Ac is higher than any of the hardness Hv of the first base electrode main surface region 31Aa or the hardness Hv of the first base electrode lateral surface region 31Ab; on the surface of the first plated layer 32A, the plurality of recessed portions 54 that are indented from the surface of the first plated layer 32A toward the multilayer body 2 and the recessed region 57 that is a region formed by the adjacent recessed portions 54 are provided; and the first base electrode layer 31A includes the metal thin film 56 that is a region between each of the pieces of glass 52 and the first plated layer 32A, includes the electrically conductive metal, and has a thickness of 1 μm or less. The first base electrode layer 31A may include an electrically conductive metal and the glass 52, and each of the pieces of glass 52 may be covered with the metal thin film 56 which is a thin film metal.

Further, the multilayer ceramic capacitor 1 includes at least any of: a configuration in which the outer surface of the first base electrode end surface region 31Ac is smoother than the outer surface of the first base electrode main surface region 31Aa; a configuration in which, in a cross section extending in parallel or substantially parallel with the lamination direction T and the length direction L and passing through the middle portion in the width direction W of the multilayer body 2, the ratio of the length of the line along the outer surface of the first base electrode end surface region 31Ac to the length of the line along the first end surface CA is smaller than the ratio of the length of the line along the outer surface of the first base electrode main surface region 31Aa to the length of the line along the portion of the first main surface AA where the first base electrode layer 31A is provided; and a configuration in which the hardness Hv of the first base electrode end surface region 31Ac is higher than any of the hardness Hv of the first base electrode main surface region 31Aa or the hardness Hv of the first base electrode lateral surface region 31Ab, and furthermore, on the surface of the first plated layer 32A, the plurality of recessed portions 55 that are indented from the surface of the first plated layer 32A toward the multilayer body 2 and the recessed region 58 that is a region formed by the adjacent recessed portions 55 are provided; and the first base electrode layer 31A includes the metal thin film 56 that is a region between each of the pieces of glass 52 and the first plated layer 32A, includes the electrically conductive metal, and has a thickness of 1 μm or less. The first base electrode layer 31A may include an electrically conductive metal and the pieces of glass 52, and each of the pieces of glass 52 may be covered with the metal thin film 56 which is a thin film metal.

In the multilayer ceramic capacitor 1, the outer surface of the first base electrode end surface region 31Ac may be smoother than the outer surface of the first base electrode main surface region 31Aa, and the hardness Hv of the first base electrode end surface region 31Ac may be higher than any of the hardness Hv of the first base electrode main surface region 31Aa or the hardness Hv of the first base electrode lateral surface region 31Ab.

In the multilayer ceramic capacitor 1, the outer surface of the first base electrode end surface region 31Ac may be smoother than the outer surface of the first base electrode main surface region 31Aa, and the surface of the first plated layer 32A may be provided with the plurality of recessed portions 54 that are indented toward the multilayer body 2 from the surface of the first plated layer 32A, and the recessed region 57 that is a region formed by the adjacent recessed portions 54.

In the multilayer ceramic capacitor 1, the outer surface of the first base electrode end surface region 31Ac is smoother than the outer surface of the first base electrode main surface region 31Aa, and the first base electrode layer 31A includes the metal thin film 56 which is a region between each of the pieces of glass 52 and the first plated layer 32A, includes the electrically conductive metal and has a thickness of 1 μm or less. The first base electrode layer 31A may include an electrically conductive metal and the pieces of glass 52, and each of the pieces of glass 52 may be covered with the metal thin film 56 which is a thin film metal.

In the multilayer ceramic capacitor 1, in the cross section extending in parallel or substantially parallel with the lamination direction T and the length direction L and passing through the middle portion in the width direction W of the multilayer body 2, the ratio of the length of the line along the outer surface of the first base electrode end surface region 31Ac to the length of the line along the first end surface CA is smaller than the ratio of the length of the line along the outer surface of the first base electrode main surface region 31Aa to the length of the line along the portion of the first main surface AA where the first base electrode layer 31A is provided, and the hardness Hv of the first base electrode end surface region 31Ac may be higher than any of the hardness Hv of the first base electrode main surface region 31Aa or the hardness Hv of the first base electrode lateral surface region 31Ab.

In the multilayer ceramic capacitor 1, in the cross section extending in parallel or substantially parallel with the lamination direction T and the length direction L and passing through the middle portion in the width direction W of the multilayer body 2, the ratio of the length of the line along the outer surface of the first base electrode end surface region 31Ac to the length of the line along the first end surface CA is smaller than the ratio of the length of the line along the outer surface of the first base electrode main surface region 31Aa to the length of the line along the portion of the first main surface AA where the first base electrode layer 31A is provided, and the surface of the first plated layer 32A may be provided with the plurality of recessed portions 54 that are indented toward the multilayer body 2 from the surface of the first plated layer 32A, and the recessed region 57 that is a region formed by the adjacent recessed portions 54.

In the multilayer ceramic capacitor 1, in the cross section extending in parallel or substantially parallel with the lamination direction T and the length direction L and passing through the middle portion in the width direction W of the multilayer body 2, the ratio of the length of the line along the outer surface of the first base electrode end surface region 31Ac to the length of the line along the first end surface CA is smaller than the ratio of the length of the line along the outer surface of the first base electrode main surface region 31Aa to the length of the line along the portion of the first main surface AA where the first base electrode layer 31A is provided, and the first base electrode layer 31A includes the metal thin film 56 that is a region between each of the pieces of glass 52 and the first plated layer 32A, includes the electrically conductive metal, and has a thickness of 1 μm or less. The first base electrode layer 31A may include an electrically conductive metal and the pieces of glass 52, and each of the pieces of glass 52 may be covered with the metal thin film 56 which is a thin film metal.

The present disclosure also includes the following combinations.

<1> A multilayer ceramic capacitor comprising: a multilayer body including a plurality of dielectric layers and a plurality of internal electrodes which are respectively laminated, a first main surface and a second main surface opposed to the first main surface in a lamination direction, a first lateral surface and a second lateral surface opposed to the first lateral surface in a width direction orthogonal to the lamination direction, and a first end surface and a second end surface opposed to the first end surface in a length direction orthogonal to the lamination direction and the width direction; a first external electrode provided on the first end surface and connected to the plurality of internal electrodes; and a second external electrode provided on the second end surface and connected to the plurality of internal electrodes, wherein the first external electrode includes a first base electrode layer connected to the plurality of internal electrodes and including electrically conductive metal and glass, and a first plated layer provided on the first base electrode layer, and the first base electrode layer includes a metal thin film which is a region between the glass and the first plated layer, includes the electrically conductive metal, and has a thickness of 1 μm or less.

<2> The multilayer ceramic capacitor according to <1>, wherein the metal thin film includes an electrically conductive metal having a highest content ratio among the electrically conductive metal included in the first base electrode layer.

<3> The multilayer ceramic capacitor according to <1>, wherein the first base electrode layer includes a first base electrode end surface region which is a region overlapping with the first end surface as viewed in the length direction, and the first base electrode end surface region includes the glass covered with the metal thin film.

<4> The multilayer ceramic capacitor according to <2>, wherein the first base electrode layer includes a first base electrode end surface region which is a region overlapping with the first end surface as viewed in the length direction, and the first base electrode end surface region includes the glass covered with the metal thin film.

<5> The multilayer ceramic capacitor according to <1>, wherein, the first base electrode layer includes a first base electrode end surface region which is a region overlapping with the first end surface as viewed in the length direction, a first base electrode main surface region which is a region overlapping with the first main surface as viewed in the lamination direction, a first base electrode lateral surface region which is a region overlapping with the first lateral surface as viewed in the width direction, and a first base electrode corner region which is a region connecting at least one of the first base electrode lateral surface region or the first base electrode main surface region to the first base electrode end surface region.

<6> The multilayer ceramic capacitor according to <6>, wherein the first base electrode corner region includes the glass covered with the metal thin film.

<7> The multilayer ceramic capacitor according to <4>, wherein the first base electrode end surface region is smoother than the first base electrode main surface region.

<8> The multilayer ceramic capacitor according to <4>, wherein a hardness of the first base electrode end region is higher than any hardness of the first base electrode layer main surface region or the first base electrode layer main lateral region.

<9> The multilayer ceramic capacitor according to <2>, wherein, the first base electrode layer includes a first base electrode end surface region which is a region overlapping with the first end surface as viewed in the length direction, a first base electrode main surface region which is a region overlapping with the first main surface as viewed in the lamination direction, a first base electrode lateral surface region which is a region overlapping with the first lateral surface as viewed in the width direction, and a first base electrode corner region which is a region connecting at least one of the first base electrode lateral surface region or the first base electrode main surface region to the first base electrode end surface region.

<10> The multilayer ceramic capacitor according to <9>, wherein the first base electrode corner region includes the glass covered with the metal thin film.

<11> The multilayer ceramic capacitor according to <9>, wherein the first base electrode end surface region is smoother than the first base electrode main surface region.

<12> The multilayer ceramic capacitor according to <1>, wherein each of the dielectric layers is made of a perovskite material.

<13> The multilayer ceramic capacitor according to <12>, wherein the perovskite material includes at least one of Ba or Ti.

<14> The multilayer ceramic capacitor according to <12>, wherein each of the dielectric layers is made of one of a dielectric ceramic including BaTiO₃, CaTiO₃, SrTiO₃, CaZrO₃.

<15> The multilayer ceramic capacitor according to <14>, wherein the dielectric ceramic further includes at least one of an Mn compound, a Mg compound, a Si compound, a Fe compound, a Cr compound, a Co compound, a Ni compound, an Al compound, a V compound, or a rare earth compound.

<16> The multilayer ceramic capacitor according to <1>, wherein each of the plurality of internal electrode is form of at least one of Ni, Cu, Ag, Pd, an Ag—Pd alloy, or Au.

<17> The multilayer ceramic capacitor according to <1>, wherein the plurality of internal electrodes includes a plurality of first internal electrodes and a plurality of second internal electrodes, and the plurality of first internal electrodes are alternately provided with the plurality of second internal electrodes.

<18> The multilayer ceramic capacitor according to <17>, wherein each of the plurality of first internal electrodes is exposed only at the first main surface.

<19> The multilayer ceramic capacitor according to <18>, wherein each of the plurality of second internal electrodes is exposed only at the second main surface.

<20> The multilayer ceramic capacitor according to <9>, wherein a hardness of the first base electrode end region is higher than any hardness of the first base electrode layer main surface region or the first base electrode layer main lateral region.

1. A multilayer ceramic capacitor comprising:
a multilayer body including a plurality of dielectric layers and a plurality of internal electrodes which are respectively laminated, a first main surface and a second main surface opposed to the first main surface in a lamination direction, a first lateral surface and a second lateral surface opposed to the first lateral surface in a width direction orthogonal to the lamination direction, and a first end surface and a second end surface opposed to the first end surface in a length direction orthogonal to the lamination direction and the width direction;
a first external electrode provided on the first end surface and connected to the plurality of internal electrodes; and
a second external electrode provided on the second end surface and connected to the plurality of internal electrodes,
wherein
the first external electrode includes a first base electrode layer connected to the plurality of internal electrodes and including electrically conductive metal and glass, and a first plated layer provided on the first base electrode layer, and
the first base electrode layer includes a metal thin film which is a region between the glass and the first plated layer, includes the electrically conductive metal, and has a thickness of 1 μm or less.

2. The multilayer ceramic capacitor according to claim 1, wherein the metal thin film includes an electrically conductive metal having a highest content ratio among the electrically conductive metal included in the first base electrode layer.

3. The multilayer ceramic capacitor according to claim 1, wherein
the first base electrode layer includes a first base electrode end surface region which is a region overlapping with the first end surface as viewed in the length direction, and
the first base electrode end surface region includes the glass covered with the metal thin film.

4. The multilayer ceramic capacitor according to claim 2, wherein
the first base electrode layer includes a first base electrode end surface region which is a region overlapping with the first end surface as viewed in the length direction, and
the first base electrode end surface region includes the glass covered with the metal thin film.

5. The multilayer ceramic capacitor according to claim 1, wherein, the first base electrode layer includes a first base electrode end surface region which is a region overlapping with the first end surface as viewed in the length direction, a first base electrode main surface region which is a region overlapping with the first main surface as viewed in the lamination direction, a first base electrode lateral surface region which is a region overlapping with the first lateral surface as viewed in the width direction, and a first base electrode corner region which is a region connecting at least one of the first base electrode lateral surface region or the first base electrode main surface region to the first base electrode end surface region.

6. The multilayer ceramic capacitor according to claim 5, wherein the first base electrode corner region includes the glass covered with the metal thin film.

7. The multilayer ceramic capacitor according to claim 4, wherein the first base electrode end surface region is smoother than the first base electrode main surface region.

8. The multilayer ceramic capacitor according to claim 4, wherein a hardness of the first base electrode end region is higher than any hardness of the first base electrode layer main surface region or the first base electrode layer main lateral region.

9. The multilayer ceramic capacitor according to claim 2, wherein, the first base electrode layer includes a first base electrode end surface region which is a region overlapping with the first end surface as viewed in the length direction, a first base electrode main surface region which is a region overlapping with the first main surface as viewed in the lamination direction, a first base electrode lateral surface region which is a region overlapping with the first lateral surface as viewed in the width direction, and a first base electrode corner region which is a region connecting at least one of the first base electrode lateral surface region or the first base electrode main surface region to the first base electrode end surface region.

10. The multilayer ceramic capacitor according to claim 9, wherein the first base electrode corner region includes the glass covered with the metal thin film.

11. The multilayer ceramic capacitor according to claim 9, wherein the first base electrode end surface region is smoother than the first base electrode main surface region.

12. The multilayer ceramic capacitor according to claim 1, wherein each of the dielectric layers is made of a perovskite material.

13. The multilayer ceramic capacitor according to claim 12, wherein the perovskite material includes at least one of Ba or Ti.

14. The multilayer ceramic capacitor according to claim 12, wherein each of the dielectric layers is made of one of a dielectric ceramic including BaTiO₃, CaTiO₃, SrTiO₃, CaZrO₃.

15. The multilayer ceramic capacitor according to claim 14, wherein the dielectric ceramic further includes at least one of an Mn compound, a Mg compound, a Si compound, a Fe compound, a Cr compound, a Co compound, a Ni compound, an Al compound, a V compound, or a rare earth compound.

16. The multilayer ceramic capacitor according to claim 1, wherein each of the plurality of internal electrode is form of at least one of Ni, Cu, Ag, Pd, an Ag—Pd alloy, or Au.

17. The multilayer ceramic capacitor according to claim 1, wherein the plurality of internal electrodes includes a plurality of first internal electrodes and a plurality of second internal electrodes, and
the plurality of first internal electrodes are alternately provided with the plurality of second internal electrodes.

18. The multilayer ceramic capacitor according to claim 17, wherein each of the plurality of first internal electrodes is exposed only at the first main surface.

19. The multilayer ceramic capacitor according to claim 18, wherein each of the plurality of second internal electrodes is exposed only at the second main surface.

20. The multilayer ceramic capacitor according to claim 9, wherein a hardness of the first base electrode end region is higher than any hardness of the first base electrode layer main surface region or the first base electrode layer main lateral region.
